(19) United States
(12) Patent Application Publication
(10) Pub. No.: US 2015/0305480 A1
(43) Pub. Date: Oct. 29, 2015

(54) LOOP SUITABLE FOR USE WITH A VARIETY OF OBJECTS

(71) Applicant: Jean-Philippe Brousseau, Gatineau (CA)

(72) Inventor: Jean-Philippe Brousseau, Gatineau (CA)

(21) Appl. No.: 14/663,653

(22) Filed: Mar. 20, 2015

Related U.S. Application Data
(60) Provisional application No. 61/968,165, filed on Mar. 20, 2014.
(60) Provisional application No. 62/135,694, filed on Mar. 19, 2015.

(51) Int. Cl. A45F 5/10; B25G 1/02; B66F 19/00

(52) U.S. Cl. CPC A45F 5/10; B66F 19/00; B25G 1/02; A45F 2005/008

(57) ABSTRACT

Disclosed is a loop suitable for a handheld object. A flexible loop is affixed e.g. via adhesive onto a smartphone and serves as a wrist strap for ease of grabbing and prevents the object from accidental drops. A feature for cleaning the object, such as a piece of microfiber cloth, can be integrated on the loop. The loop may be fixed onto almost anything, such as handheld devices, remotes, keys, protective cases, wallets, etc. None of an objects function is impaired. A back strap loop is disclosed for holding a device with one hand. A flat strap loop is disclosed for holding a device and for a wristband for public events. An awareness ribbon loop is disclosed for holding a device. Components are highly customizable in regards to colour, shape, dimension, print, etc., the overall design of which may help a user to make their object unique, particularly as a promotional item.

### CROSS-REFERENCE TO RELATED APPLICATIONS

The present application is related to application U.S. provisional patent application, Ser. No. 61/968,165, filed Mar. 20, 2014, for LOOP FOR HANDHELD OBJECT, by Jean-Philippe Brousseau, included by reference herein and for which benefit of the priority date is hereby claimed.

The present application is related to U.S. provisional patent application, Ser. No. 62/135,694, filed Mar. 19, 2015, for LOOP SUITABLE FOR USE WITH A VARIETY OF OBJECTS, by Jean-Philippe Brousseau, included by reference herein and for which benefit of the priority date is hereby claimed.

### TECHNICAL FIELD

This application relates to attachment mechanisms and methods of use thereof, and more particularly to a loop suitable for use with a variety of objects, in particular.

### BACKGROUND OF THE APPLICATION

Because of their size and weight, the handheld objects are easily transportable and thus people always carry them in their lifestyle activities such as walking, transiting, working, etc. Devices that belong to this category include, for example, mobile phones, tablets and portable diabetes devices. Handheld objects will also include non-electronic items such as wallets, bunch of keys, containers, etc. In some cases, the objects are held in the user's hand or rest in a pocket, while in other cases the objects are worn by the user thus freeing their hands. Sometimes, the objects are risky to handle with one hand. For example, a user would wear the wrist strap of a point and shoot camera.

Some handheld objects, especially mobile phones, may lack of such safety straps. Those devices are ubiquitous, and users are constantly manipulating them. Sometimes, they slip out of hands and violently drop to the ground, in some other cases they are kept in a pocket, and occasionally, they get snatched. They also tend to get dirty from fingerprints. Furthermore, since many handheld objects look alike, the need to customize such personal items is understandable. The shortcomings of the prior art may generally be lack of versatility, compatibility and customizability. As for smartphones, some specific solutions exist, such as dedicated loop, hack on leash and cases with bulky wrist strap, but these may be one-off solutions and not a one-size fits all solution.

U.S. patent application Ser. No. 09/894,596 filed 28 Jun. 2001 for “ATTACHMENT LOOP FOR A HANDHELD DEVICE” by Michael J. Pratl discloses an attachment loop for affixing to a handheld device. The attachment loop includes a self-adhesive base panel having a ring portion pivotally attached thereto. A segment of the ring portion is captured within a channel of the base panel. The base panel has an end profile generally matching the inside opening profile of the ring portion to permit the ring portion to lay flush against the surface of the handheld device.

U.S. patent application Ser. No. 11/212,514 filed 24 Aug. 2005 for “LANYARD FOR HANDHELD ELECTRONIC DEVICE” by Daniele De Iuliis et al discloses a lanyard for carrying or wearing portable electronic devices. The lanyard includes a neck cord having data carrying capabilities. The lanyard also includes a harness that physically holds and operatively couples the portable electronic device to the neck cord. When a portable electronic device is coupled to the harness, the portable electronic device can be worn around a neck and communicate with an input and/or output (I/O) device (e.g., earphones) operatively coupled to the data carrying cord. That is, the I/O device can send data through the neck cord to the portable electronic device and/or receive data being carried by the neck cord from the portable electronic device. The lanyard facilitates greater ease in wearing portable electronic devices and enables better approaches for managing wires between portable electronic devices and peripheral I/O devices.

U.S. patent application Ser. No. 11/543,331 filed 5 Oct. 2006 for “STICK-ON SECURITY RING FOR A HAND HELD DEVICE” by Gregory B. Myers discloses a button that provides an adhesive flat bottom surface for attachment to a cell phone or similar hand held device. A leash extends from the button and terminates with a finger ring. When the device is held in a hand with one finger secured in the ring, the device is secured in the hand so that it is less likely to fall. The ring may be an extension of the leash, both a part of an elastic cord loop where the leash is secured within the button and the ring extends away from the button. The leash may be retractable.

U.S. patent application Ser. No. 13/316,074 filed 9 Dec. 2011 for “LANYARD APPARATUS FOR CARRYING DEVICES” by Shane Hedrick discloses an apparatus for carrying hand held electronic and other types of devices that includes a flexible substrate and a lanyard secured to the substrate. The substrate has opposite first and second surfaces and opposite first and second end portions. A layer of adhesive material is applied to at least a portion of the substrate first surface, and a protective layer of material is releasably secured to the adhesive material. When the protective layer is removed, the adhesive material is exposed such that the substrate can be secured to a device via the adhesive material. The adhesive material is intended to securely attach the substrate to the device and such that removal therefrom is difficult. The lanyard allows for the substrate and an attached device to be suspended around the neck of a user.

U.S. patent application Ser. No. 13/316,376 filed 9 Dec. 2011 for “LEASH FOR AN ELECTRONIC DEVICE” by Kenneth Y. Minn et al discloses a leash for an electronic device, with a data port, comprising: a connector; a singular cord; an elastomeric coating; a protective element; and a washer. The connector includes a broad face, an insertable member adjacent to the broad face and configured to engage the data port, and a latch configured to selectively lock the insertable member to the data port. The singular cord includes a first and second end and defines a spring-loop junction therebetween, wherein the second end is arranged proximal to the spring-loop junction to form a loop. The elastomeric coating is arranged over the cord between the first end and the spring-loop junction and defines a spring section therebetween. The protective element is arranged over the spring-loop junction and the second end of the cord. The washer couples the first end to the connector, the cord extending from the broad face of the connector.

The shortcomings of the aforementioned existing solutions may be three-fold. First, some solutions may involve mechanical apparatus including metallic or plastic parts that may be too bulky or expensive to manufacture. Second, some solutions may be relatively less bulky, yet still may require some significant expense in manufacturing due to the use of components that need to be assembled, for example sewn together; they also may require significant non-recurrent engineering in order to accommodate different devices of the same class, such as cellular or smart phones. Third, some solutions may require significant non-recurrent engineering in order to accommodate different classes of objects for different applications; some solutions provide points of attachment for lanyards to be worn around the neck, other solutions provide points of attachment for anchoring to the body, yet other solutions provide for a strap to be held by the hand via a ring on the hand.

### SUMMARY

According to an aspect of the present application, there is provided: a loop suitable for use with an object, the loop including: a strap having a top end and a bottom end folded-over and affixed to each other thereby forming a front side, a backside, an outside face, and an inside face of the loop; a self-adhesive portion provided at the top end and the backside of the loop suitable for affixing the loop to the object; and a microfiber cloth provided in a clasp that wraps around the strap like a tube or a portion of the strap. The bottom end of the loop hangs loose, such as a standard wrist strap would do, when the loop is affixed to the object.

According to another aspect of the present application, a loop suitable for use with a workpiece object, the loop including: a strap having a top end and a bottom end and a portion in-between; a first self-adhesive portion provided at the top end, bottom end, or the portion in-between; a second self-adhesive portion provided at the top end, bottom end, or the portion in-between. The first and second self-adhesive portions are suitable for affixing the strap to the workpiece object thereby forming the loop.

According to yet another aspect of the present invention, there is provided: a loop suitable for use with an object, the loop including: a strap having a top end and a bottom end; an affixing portion including a self-adhesive portion provided at the top end, bottom end, or in-between the top end and the bottom end, of the strap. The strap is folded-over or cuffed to form the loop. The affixing portion provides at least one strap-affixing portion suitable for affixing the loop to the object.

In some embodiments, the length of the loop is suitable for an average human to use the bottom end of the loop as a wrist strap or an attachment to a cord, chain, carabineer, retractable reel, ring, or leather strap.

In some embodiments, a microfiber cloth is integrated in the loop in a clasp that wraps around the strap like a tube, or in a portion of the strap.

In some embodiments, the material of the loop is elastic, inelastic, plastic, polyester ribbon, microfiber, card, paper, kraft paper, or high-density polyethylene fibres.

In some embodiments, the width of the strap is suitable for passing a portion of the strap in an opening in a protective case for a handheld device.

In some embodiments, a portion the strap is made from a material flexible enough and thin enough to have a thickness that is suitable for conforming a portion of the strap that includes the strap-affixing portion between two parts of an assembly.

In some embodiments, the two ends of the strap are joined together to form the top end of the loop by a junction.

In some embodiments, the junction is provided by heat welding, ultrasonic welding, adhesive transfer, tape, glue or fastener.

In some embodiments, the junction is a simple fold or a cross fold.

In some embodiments, the top end of the loop has a tip that is an angle cut, V cut, straight cut, glue, or fold.

In some embodiments, the top end of the loop matches an exterior profile of curvature of a device.

In some embodiments, the loop includes a pattern, color, texture, brand mark, logo, drawing, writing, identifying the loop, trademark, branding icon, acronym or slogan.

In some embodiments, the strap includes an accessory such as a bead, ring, clip, ornament, reel, leash, chain, or key ring.

In some embodiments, the loop is an awareness ribbon loop.

In some embodiments, the loop resists a human pulling force.

In some embodiments, the loop includes a packaging solution with a card or a protective liner, such that the loop is temporarily affixed to one the card or the protective liner for packaging purposes.

In some embodiments, the object is a mobile phone, smartphone, tablet, electronic book, camera, remote control, portable diabetes device, protective case, container, wallet, keys, key ring, ID pass, beauty item, card, or a protective liner.

In some embodiments, the affixing portion includes a second self-adhesive layer, hook, T shaped tab, permanent affixing element, releasable affixing element, or integration as a part of the object. The affixing portion has adequate strength to support a weight of the object to ensure that a junction between the loop and the object remains intact if the loop is pulled.

In some embodiments, includes a clasp that wraps around the strap like a tube.

In some embodiments, the affixing portion is provided by a self-adhesive layer that is non-permanent and non-marking so an integrity of the object where it is affixed is preserved, yet strong enough to resist shear forces of the order of a human pulling force.

In some embodiments, the loop includes an other affixing portion provided at the bottom end, top end, or in-between the top end and the bottom end, of the strap.

In some embodiments, the one affixing portion and the other affixing portion are suitable to be affixed to a workpiece thereby providing the loop.

In some embodiments, the workpiece is at a protective case for the object, or the strap.

In some embodiments, the strap is affixed to the protective case via an opening in the protective case such as a feature opening or an opening intended to receive the object for which the protective case provides protection.

In some embodiments, the feature opening is a speaker opening, a camera opening, a data port opening, or an other opening.

In some embodiments, the size of the loop is adjustable to the size of a hand of a person.

In some embodiments, the loop enables a person to operate the object with one hand, locate the object, pull the object, wear and secure the object on a wrist, hand or fingers, use the object in a hands-free fashion, use the object in a hands-relaxed manner, or prevent the object from falling.

In some embodiments, a cutting profile for cutting the strap is a die-cut and the loop further provides a printing area for a wristband identification marker or other designs.

In some embodiments, once affixed to the object, removing the loop from a wrist would compromise the integrity of the wristband identification marker.

In some embodiments, the affixing portion is of a wider width or the same width as the remaining portion of the strap.

Some embodiments of the present application provide an aftermarket loop accessory, compatible with any kind of handheld object.

Some embodiments further provide a cleaning apparatus for dirty surfaces.

Furthermore, by offering a highly customizable design, some embodiments of the present application also addresses the need for a user to customize his or her handheld object, and are particularly suitable as promotional items.

Some embodiments of the present application pertain to improved approaches for manipulating, cleaning and customizing a portable item, such as mobile phones.

In one aspect, some embodiments of the present application provide an apparatus for affixing to a handheld object. The loop acts as an add-on leash that matches and fits almost every variety of handheld objects, such as, but not limited to, smartphones.

In another aspect, some embodiments of the present application relates to making handheld objects easier to secure on the body of the user, such as on wrist and fingers, providing an apparatus that prevents the handheld object from drops, losses, snatch thefts, etc. The loop also helps to locate, grab and pull out the handheld object from one's pocket, jacket, purse, etc. Additionally, some embodiments of the present application allow a method of connecting a handheld object to an external support element, such as a ring, a carabineer, etc.

In still another aspect, some embodiments of the present application provide a method for cleaning any smooth surface, such as lenses and touch screens. Some embodiments of the present application enable a user to carry a cleaning apparatus, affixed on his or her handheld object where cleaning is needed.

In yet another aspect, some embodiments of the present application offer a solution for customizing one's handheld object. Since components of the present application are highly customizable, they provide a way to create multiple different models, including versions with acronyms, slogans, patterns, logos, symbols, brand marks, etc.

Other aspects and features of the present invention will become apparent to those ordinarily skilled in the art upon review of the following description of specific embodiments of a loop suitable for use with a variety of objects in conjunction with the accompanying drawing figures.

### BRIEF DESCRIPTION OF THE DRAWINGS

Embodiments of the present application will now be described, by way of example only, with reference to the accompanying drawing figures, wherein:

FIG. 1 is an exploded perspective view of an example loop affixed onto an example protective case of an example smartphone, provided according to an embodiment of the present application;

FIG. 2A is a front perspective view of the exemplary loop of FIG. 1, affixed onto an example packaging solution, provided according to an embodiment of the present application;

FIG. 2B is a rear perspective view of the example loop and example packaging solution of FIG. 2A;

FIG. 3A is a perspective backside view of the example loop of FIGS. 2A-2B, wherein a protective liner is being peeled off from a self-adhesive layer of the loop and wherein a microfiber cloth is integrated on the strap of the loop, provided according to embodiments of the present application;

FIG. 3B is a perspective backside view of the example loop of FIG. 3A, with the self-adhesive layer fully exposed, provided according to an embodiment of the present application;

FIG. 4 is a perspective backside view of an another example loop with another example microfiber cloth integration aspect, as a clasp tube, provided according to an embodiment of the present application;

FIG. 5 is a perspective view of a variation of the example loop of FIG. 4 affixed on another example smartphone, provided according to an embodiment of the present application;

FIG. 6 is a perspective view of the example loop of FIG. 4 attached to an example key ring, provided according to an embodiment of the present application;

FIG. 7 is a perspective view of the example loop of FIG. 4, affixed onto an example wallet, provided according to an embodiment of the present application;

FIG. 8 is a perspective view of the example loop of FIG. 4 fitted between an example tablet computer and its example protective case, provided according to an embodiment of the present application;

FIG. 9 is a front view of an example back strap loop, with an example protective liner to cover a self-adhesive layer on the back strap loop, provided according to an embodiment of the present application;

FIG. 10 is a perspective view of an integration of the example back strap loop of FIG. 9 onto the example protective case inside face of FIG. 1 and example smartphone of FIG. 1, provided according to an embodiment of the present application;

FIG. 11A is a back view of an assembly of the example back strap loop of FIG. 9, example protective case of FIG. 10, and example smartphone of FIG. 10, provided according to an embodiment of the present application;

FIG. 11B is a right side view of the assembly of the example back strap loop of FIG. 11A, example protective case of FIG. 11A, and example smartphone of FIG. 11A, provided according to an embodiment of the present application;

FIG. 12 is a perspective view of the assembly of the example back strap loop of FIG. 11A, example protective case of FIG. 11A, and example smartphone of FIG. 11A, provided according to an embodiment of the present application;

FIG. 13 is a back view of the assembly of the example back strap loop of FIG. 11A, example protective case of FIG. 11A, and example smartphone of FIG. 11A and the interaction with a hand, provided according to an embodiment of the present application;

FIG. 14A is a front view of an of an example flat strap loop, provided according to an embodiment of the present application;

FIG. 14B is a right side view of the example flat strap loop of FIG. 14A, provided according to an embodiment of the present application;

FIG. 14C is a back view of the example flat strap loop of FIG. 14A, showing a self-adhesive layer, provided according to an embodiment of the present application;

FIG. 15 is a perspective view of an example single end self-adhesive strap, provided according to an embodiment of the present application;

FIG. 16 is a perspective view of an example double end self-adhesive strap, provided according to an embodiment of the present application;

FIG. 17 is a front view of an example awareness ribbon loop, provided according to an embodiment of the present application;

FIG. 18 is a front view of an assembly of the example awareness ribbon loop of FIG. 17, example protective case of FIG. 1, and example smartphone of FIG. 1, provided according to an embodiment of the present application;

FIG. 19A is a back perspective view of an integration of the example loop of FIG. 4 with an example remote control device having a battery door, provided according to an embodiment of the present application; and

FIG. 19B is a top perspective view of the integration of the example loop of FIG. 19A with the example remote control device having a battery door of FIG. 19A, provided according to an embodiment of the present application;

FIG. 20 is a perspective view of the example strap 13s of FIG. 16, affixed onto an example pencil, provided according to an embodiment of the present application;

FIG. 21 is a perspective view of the example strap 13s of FIG. 16, affixed onto an example product, provided according to an embodiment of the present application.

Like reference numerals are used in different figures to denote similar elements.

### DETAILED DESCRIPTION OF THE DRAWINGS AND PREFERRED EMBODIMENT

Some embodiments of the present application will be described hereinafter. Although some embodiments of the present application are described in terms of specific illustrative example embodiments, it is to be understood that the embodiments described herein are by way of example only and that the scope of the embodiments of the present application is not intended to be limited thereby.

Referring now to the drawing figures, it is noted that like reference numerals represent like parts.

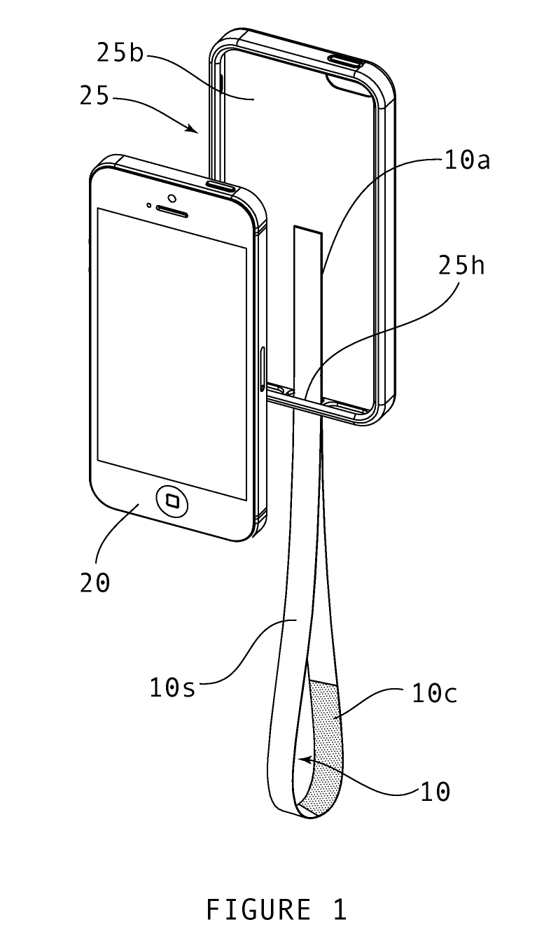

FIG. 1 is an exploded perspective view of an example loop 10 affixed onto an example protective case of an example smartphone, provided according to an embodiment of the present application. The loop 10 includes a top end and a bottom end, a front side and a backside, and an outside face and an inside face. The loop 10 is preferably made of a thin and flexible strap 10s and includes a strap self-adhesive layer 10a (at least one affixing portion, a strap-affixing portion) on its top end backside that sticks onto the handheld protective case 25 and in some embodiments onto the inside face of the protective case 25b. While the top end of the loop 10 is affixed, the bottom end of the loop 10 passes through an opening in the protective case 25h, and hangs loose, such as a standard wrist strap would do. As illustrated, the loop 10 also includes an optional feature for cleaning the device, illustrated as a microfiber cloth 10c, integrated on the inside of the strap 10s. In preferred forms, embodiments of the present application are convenient to use, and fit flush on the surface of the device to which it is affixed.

The strap 10s is made from a material flexible enough, and thin enough to seamlessly integrate a handheld object and/or be squeezed in-between two parts, such as a smartphone handheld device 20 and its handheld protective case 25. Suitable materials shall resist a human pulling force. For example, polyester ribbon may be appropriate. The strap 10s is folded onto itself to close a loop 10. Both ends of the strap 10s are joined together to form the top end of the loop 10. That junction may be permanent, and thus manufactured by, but not limited to, one of: heat welding, adhesive transfer tape, glue, etc. Illustrated strap 10s shows a simple fold over assembly, but some embodiments may have any kind of twist within the strap 10s, such as awareness ribbon cross folds. Although not expressly shown in the drawings, in some embodiments, the ends of the strap 10s after the fold over assembly are more or less flush with one another, depending on the application. In other embodiments, at least one end of the strap 10s is left uncovered after the fold over assembly, such as for example to leave a section of adhesive transfer tape exposed on the uncovered portion of the at least one end of the strap 10s. Although not expressly shown in the drawings, in some embodiments, the top end of the loop 10 may have any kind of angle cut, V cut, straight cut, etc.

As the top end of the loop 10 matches the exterior profile of curvature of the device, the bottom end of the loop 10 that hangs freely by the device must resist a human pulling force. In preferred form, the length of the loop's top end is as short as possible, for minimal footprint on the device where it is affixed, and the length of the loop's bottom end allows a user to comfortably grab and slip onto his or her wrist. A length of more or less six inches is enough for an average human to use the bottom end of the loop 10 as a wrist strap 10s. In another preferred form, the bottom end of the loop 10 presents a minimal length that allows attachment to any type of cord, chain, carabineer, retractable reel, thicker leather strap and the like. Some embodiment implies that the loop 10 passes through a specific hole, such as a data port opening or other like opening in the protective case 25h, without altering its functionality, and therefore restricts some embodiments of the strap 10s to a maximum width and thickness for some applications. Advantageously, a person of ordinary skill in the art is enabled by the present application to select a suitable width of a strap 10s for a large class of handheld devices on the basis of the minimal size of the opening in the protective cases for that class of handheld devices, which in turn can be determined by looking at the minimal size of features of a class of handheld device 20 that would require a corresponding suitably sized opening in the protective case 25h. Likewise advantageously, a person of ordinary skill in the art is enabled by the present application to select a suitable thickness of a strap 10s for a large class of handheld devices on the basis of the tolerances in the space between a large class of handheld devices and their corresponding protective cases.

In some embodiments, the strap 10s may feature different patterns, colors, textures, brand marks, logos, acronyms, slogans, etc. It may also offer a space for drawing, writing, identifying the loop 10, etc. Even more, it may feature beads and all sort of montage.

Furthermore, as camera lenses, glasses, and touch screens tend to get dirty, some embodiments of the present application offer a solution for cleaning such surfaces. The loop 10 here features a section of microfiber cloth 10c on the inside of the strap 10s, to allow a user to clean the touch screen of the handheld device 20, whenever needed. The way of affixing such a fabric are various, for example, pressure sensitive adhesive transfer tape, thermo adhesive fabric, sewing, etc. Such a cleaning feature is not limited to a single section of fabric; although not expressly illustrated, it may be integrated all around the strap 10s, inside and/or outside. In fact, the strap 10s itself may be made of microfiber material. Moreover, other forms of integration of a cleaning microfiber cloth 10c are also possible and are contemplated as embodiments of the present application.

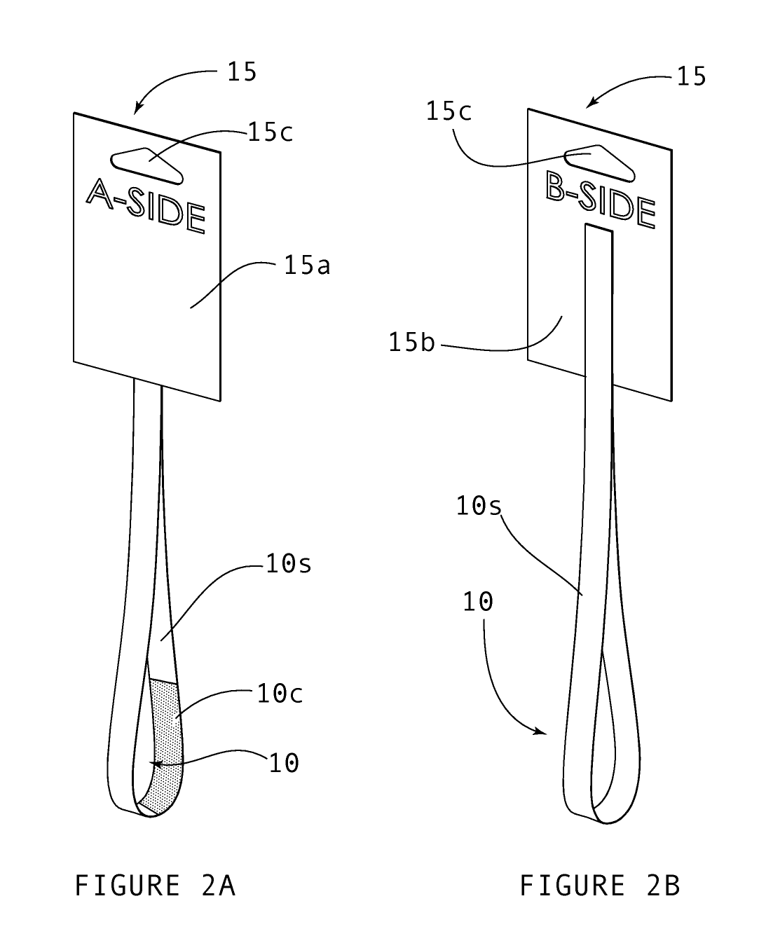

FIG. 2A is a front perspective view of the exemplary loop 10 of FIG. 1, affixed onto an example packaging solution, provided according to an embodiment of the present application. FIG. 2B is a rear perspective view of the example loop 10 and example packaging solution of FIG. 2A. Card 15 provides for an embodiment including a packaging solution. The card 15 features an A-SIDE 15a and a B-SIDE 15b that are meant to show brand marks, logos, information, drawings, instructions for applying the loop 10, etc. The loop 10 is temporarily affixed to the card 15 (e.g. with adhesive, wrapped around, or otherwise) for packaging purposes. The card 15 is fully customizable with many shapes, colours, and printed material. One embodiment features a cut out 15c for hanging the product, as seen on retail stands. Different cut out 15c patterns may also exist to hold the loop 10 on the card 15.

Components of embodiments of the present application are highly customizable in terms of materials, colors, prints, branding, shapes, textures, etc. As illustrated in FIG. 2A-2B, some embodiments of the present application are particularly suitable as an original, new and useful promotional item, or as a simple aftermarket accessory. The overall design of the loop 10 in some embodiments, including packaging, advantageously involves very few parts and optimal manufacturing processes to ensure minimal cost of fabrication.

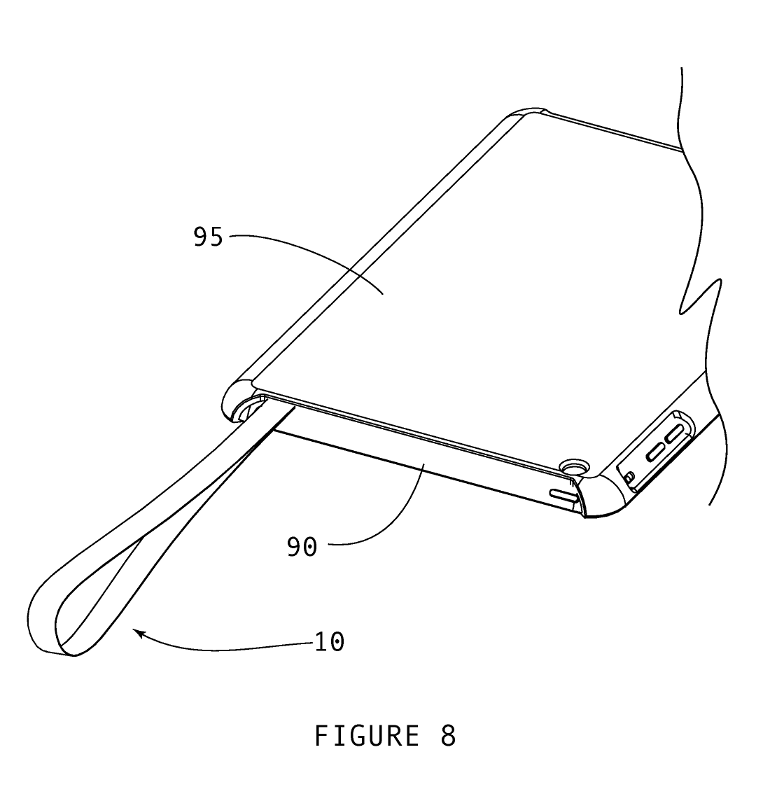

Exemplary objects that may be carried by the loop 10 include, but are not limited to, electronic devices such as mobile phones, tablets, electronic books, cameras, remote controls, portable diabetes devices, etc. FIGS. 1,2,5-8 illustrate embodiments of the loop 10 affixed to different classes of handheld objects. For example, FIG. 8 illustrates an embodiment of the loop 10 squeezed in between a tablet 90 and its tablet protective case 95. In addition, various non-electronic objects may be carried, including, but not limited to, containers, wallets, bunch of keys, ID passes, beauty items, pens and pencils, etc. FIGS. 1-3,5-7 illustrate substantially the same loop 10 affixed to a handheld device 20 case, a card 15, a strap protective liner 101, a handheld device with feature 60, a key ring 70, a wallet 80, and a tablet 90 and/or tablet protective case 95 respectively. Advantageously, a user could elect to detach the loop 10 from one object and attach it to another object.

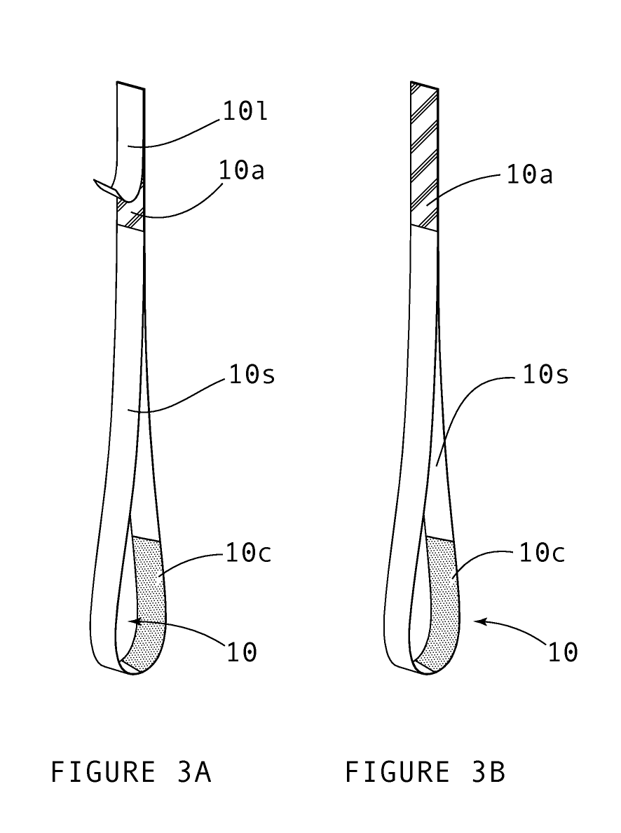

FIG. 3A is a perspective backside view of the example loop 10 of FIGS. 2A-2B, wherein a protective liner is being peeled off from a self-adhesive layer of the loop 10 and wherein a microfiber cloth 10c is integrated on the strap 10s of the loop 10, provided according to embodiments of the present application. FIG. 3B is a perspective backside view of the example loop 10 of FIG. 3A, with the self-adhesive layer (at least one affixing portion, strap-affixing portion) fully exposed, provided according to an embodiment of the present application. In some embodiments, the card 15 of FIGS. 2A-2B may also directly serve as the protective liner for the strap self-adhesive layer 10a, so when the loop 10 and the card 15 are separated, the strap self-adhesive layer 10a is exposed.

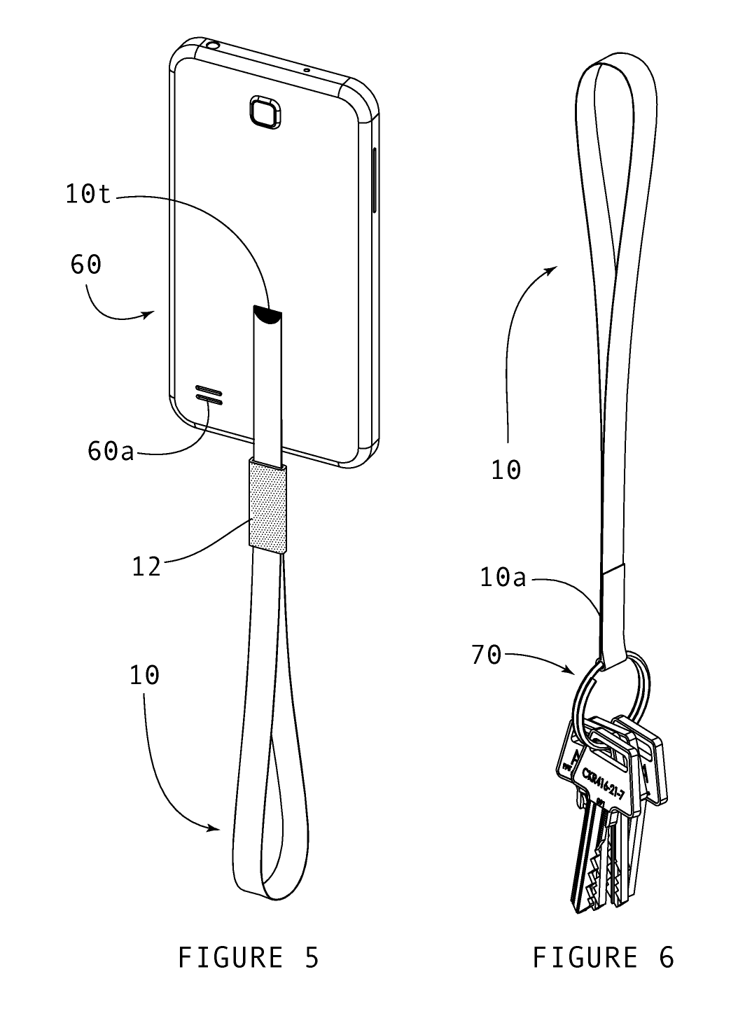

As illustrated in FIG. 3A, when the strap protective liner 101 is removed, the self-adhesive layer is uncovered and ready to be applied on any surface. No additional operation shall be required from a user in order to apply and use the loop 10. In one embodiment, the loop 10 can either be stuck to a device or its protective case, as in for example FIG. 1, FIG. 5 and FIG. 8. In another embodiment, as illustrated in FIG. 6, the top end of the loop 10 may be folded over itself to wrap on a key ring 70.

Although not expressly shown in the drawing, alternatively, the loop 10 is affixed to the handheld device 20 or its handheld protective case 25 by other mechanical elements, such as, but not limited to, another self-adhesive layer, hooks, T shaped tabs, fasteners, and/or by other permanent affixing element or releasable affixing element. It may also be an integral part of the design of a device, such as a handheld protective case 25. The affixing technique is selected to ensure adequate strength to support the weight of the handheld device 20 and to ensure that the connection between the attachment loop 10 and the handheld device 20 remains intact if the loop 10 is pulled. Some embodiments of the present application provide greater safety, prevent drops and losses, and improve ease of reach within pockets, jackets, purses, car seats, etc.

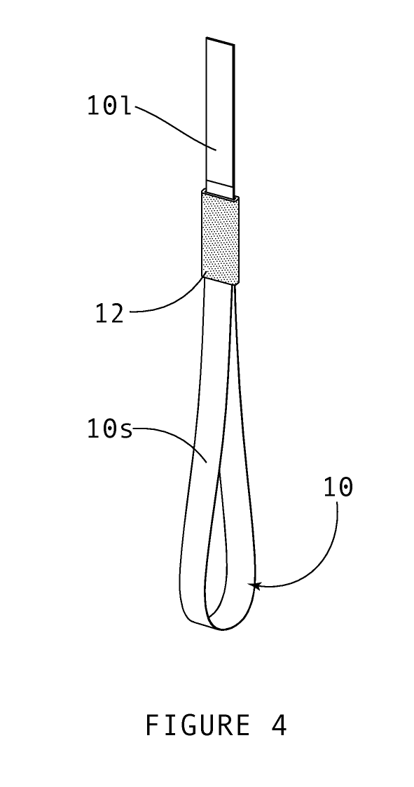

FIG. 4 is a perspective backside view of another example loop 10 with another example microfiber cloth 10c integration aspect, as a clasp tube, provided according to an embodiment of the present application. As illustrated in FIG. 4, an adjustable clasp 12 made of microfiber cloth 10c wraps around the strap 10s like a tube. The clasp 12 slides freely on the strap 10s and serves as a microfiber cloth 10c. In some embodiments, a standard clasp may also be integrated as a simple adjustable feature for the loop 10, without any cleaning purpose. As illustrated, a double-sided adhesive tape has been transferred with its protective liner to the top end backside of the strap 10s thereby providing the strap protective liner 101. In some embodiments, the strap protective liner 101, such as kraft paper, may feature drawings, information, logos, acronyms, etc.

FIG. 5 is a perspective view of a variation of the example loop 10 of FIG. 4 affixed on another example smartphone, provided according to an embodiment of the present application. As the top end of a ribbon tends to fray, some embodiments of the present application may also have a folded tip 10t, as illustrated in FIG. 5, to seal the end. Such a tip 10t may also serve as an aesthetic feature and/or represent a branding icon or trademark. As illustrated in FIG. 5, a tip 10t in that example is made of a self-adhesive dot, folded over the top end of the loop 10. Although not expressly shown in the drawings, a heat-cut or some glue can play those roles too. The loop 10 is preferably affixed to the handheld device with feature 60 by pressure-sensitive adhesive, such as a self-adhesive layer 10A. In preferred forms, the adhesive may be non-permanent and non-marking, so the integrity of the device where it is affixed is preserved. To ensure seamless integration on the device, the thickness of the strap self-adhesive layer 10a is minimal, but strong enough to resist shear forces. The strap self-adhesive layer 10a is intended to securely fix the loop 10 to the device itself or its handheld protective case 25, so it withstands a human pulling force. The adhesive may also be repositioned by peeling off the loop 10 from the device, without damaging any surface. Some embodiments of the present application seamlessly integrate the object so none of its function is impaired. As many models of objects exist, features like speakers, cameras, buttons and ports shall not be obstructed. The one-size fits all solution must have a minimum foot print on the object for a seamless integration. For example, referring to FIG. 5, the loop 10 is affixed on the back of a handheld device with feature 60, without compromising the speaker feature 60a thereof.

FIG. 6 is a perspective view of the example loop 10 of FIG. 4 attached to an example key ring 70, provided according to an embodiment of the present application. As illustrated, the top end of the loop 10 has been simply folded over onto itself such that a first portion of the strap self-adhesive layer 10a adheres to a second portion of the strap self-adhesive layer 10a to secure the key ring 70 to the top of the loop 10. Although not expressly shown in the drawings, in some embodiments instead of adhering the first and second portions of the strap self-adhesive layer 10a directly to each other, the two portions can be affixed to either side of the protection liner 101 of FIG. 3A or another similarly wide and thin member can be used, so as to facilitate an assembly that allows for the easy separation of the portions of the strap self-adhesive layer 10a adhering to itself in a releasable fashion. Although not expressly shown in the drawings, in some embodiments a small plastic, metal, cardboard tube or even the protective liner 101 itself can be used so as to allow the key ring 70 to move freely can be used between the first and second portion of the strap self-adhesive layer 10a so as to facilitate a sliding engagement between the loop 10 and the key ring 70.

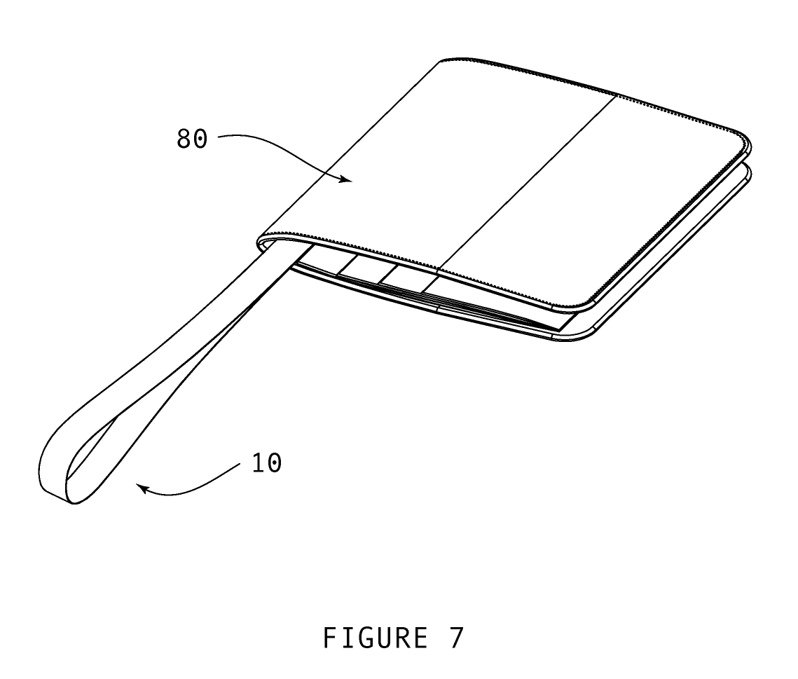

FIG. 7 is a perspective view of the example loop 10 of FIG. 4, affixed onto an example wallet 80, provided according to an embodiment of the present application. Although not expressly shown in the drawing, there are many options for affixing the loop 10 onto a wallet 80, including but not limited to a fold of the wallet 80 or the inside of a pocket of the wallet 80. Advantageously, such configurations ensure that the forces normally in play while the wallet 80 is closed will tend to keep the loop 10 affixed to the wallet 80.

FIG. 8 is a perspective view of the example loop 10 of FIG. 4 fitted between an example tablet 90 computer and its example protective case, provided according to an embodiment of the present application. Although not expressly shown in the drawing, in alternative embodiments, the loop 10 can be affixed to the tablet 90, the tablet protective case 95, or both. The same applies to the handheld device 20 and handheld protective case 25.

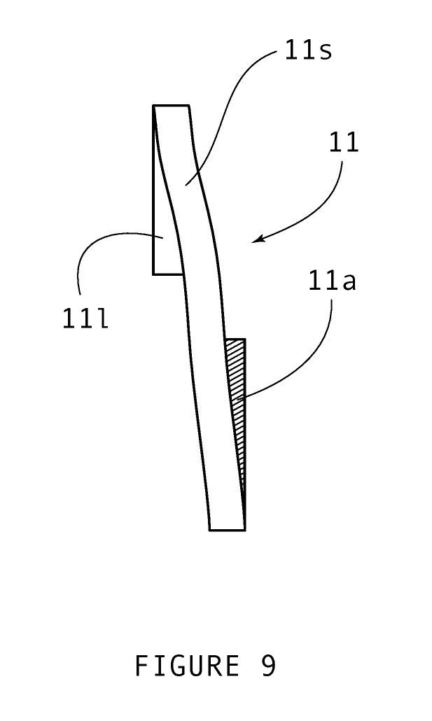

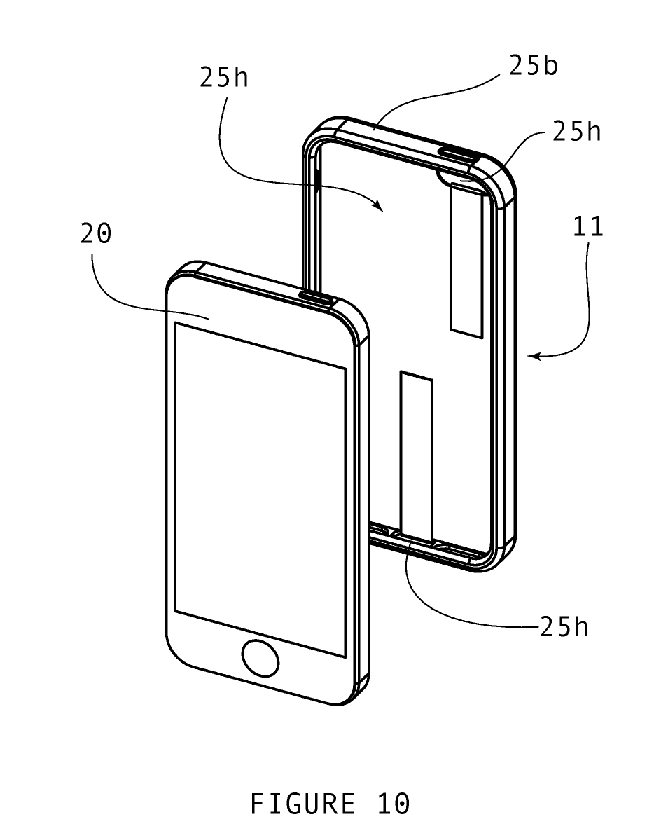

FIG. 9 is a front view of an example back strap loop 11, with an example protective liner to cover a self-adhesive layer on the back strap loop 11, provided according to an embodiment of the present application. Compared with the loops so far described, the embodiment of the back strap loop 11 illustrated in FIG. 10 features a back strap 11s having two ends that are not assembled to each other. As illustrated, the back strap 11s has a back strap self-adhesive layer 11a (at least one affixing portion, strap-affixing portion) that is exposed at the bottom end, and a back strap self-adhesive layer 11a that is covered by a back strap protective liner 111 at the top end.

FIG. 10 is a perspective view of an integration of the example back strap loop 11 of FIG. 9 onto the example protective case inside face of FIG. 1 and example smartphone of FIG. 1, provided according to an embodiment of the present application. Advantageously, the back strap loop 11 is formed when each of the two back strap self-adhesive layer 11a are assembled to a workpiece object, which as illustrated in this embodiment is the handheld protective case 25. Advantageously, the width of the back strap 11s is smaller than the smallest of each of the two opening in the protective case 25h. Each of the two ends of the back strap 11s having a back strap self-adhesive layer 11a is fed through each of the two opening in the protective case 25h such that the two back strap self-adhesive layer 11a are adhered to the inside face of the protective case 25b thereby assembling the back strap loop 11.

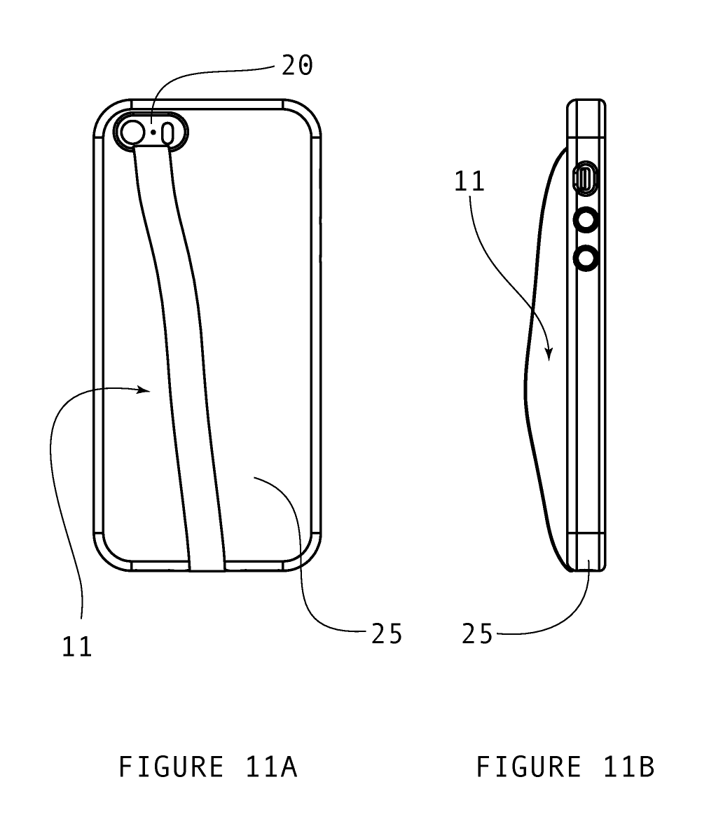

FIG. 11A is a back view of an assembly of the example back strap loop 11 of FIG. 9, example protective case of FIG. 10, and example smartphone of FIG. 10, provided according to an embodiment of the present application. FIG. 11B is a right side view of the assembly of the example back strap loop 11 of FIG. 11A, example protective case of FIG. 11A, and example smartphone of FIG. 11A, provided according to an embodiment of the present application. As illustrated, two opening in the protective case 25h corresponding to features of the handheld device 20 were re-used, and are readily available in many classes of handheld protective case 25 for a plethora of handheld device 20: the camera port and the data port respectively. In other embodiments, other opening in the protective case 25h can be used for this purpose.

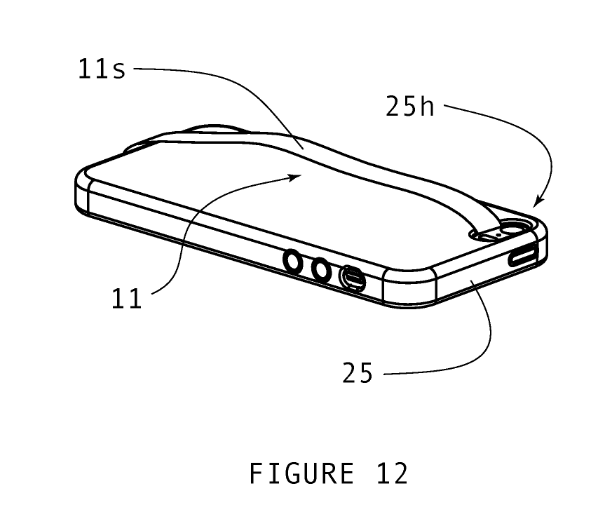

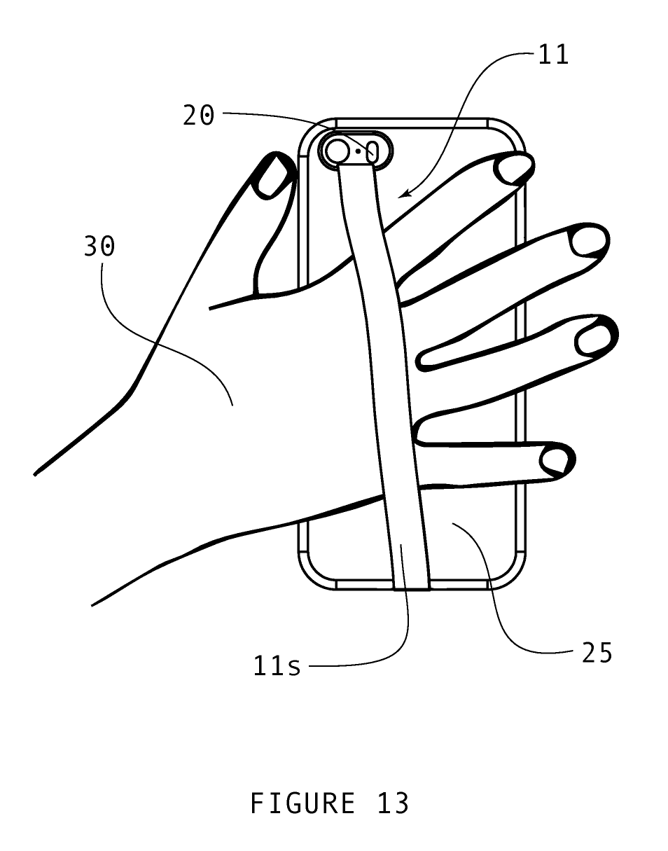

FIG. 12 is a perspective view of the assembly of the example back strap loop 11, example handheld protective case 25, and example smartphone of FIG. 11A, provided according to an embodiment of the present application. In alternative embodiments, the opening in the protective case 25h that is used to receive the handheld device 20 is used for at least one, and possibly both ends of the back strap 11s having respective back strap self-adhesive layer 11a at each end. For example, instead of going through the data port opening in the protective case 25h, the bottom end of the back strap 11s could go under the bottom of the handheld protective case 25, and be affixed to the inside face of the protective case 25b through the main front opening in the protective case 25h intended to receive the handheld device 20. Similarly, although not expressly shown in the drawing, instead of going through the camera opening in the protective case 25h, the top end of the back strap 11s could go over the top of the handheld protective case 25, and be affixed to the inside face of the protective case 25b through the main front opening in the protective case 25h intended to receive the handheld device 20. Furthermore, although not expressly shown in the drawing, back strap loop 11 can be formed by affixing back strap 11s onto itself, in the manner of a wristband, such that the back strap 11s acts as the workpiece object, either alone, or in combination with the handheld protective case 25. For example, if one of the two self-adhesive layer 11a is placed on one side of the back strap 11s, and the other self-adhesive layer 11a is placed on the other side of the back strap 11s, folding-over back strap 11s after having passed one end through the camera protective opening 25h and the other end through either the main or data port protective opening 25h, results in an assembly wherein the back strap loop 11 can be freely slid while assembled to the handheld protective case 25 when the handheld device 20 is not inserted into the handheld protective case 25, and more solidly affixed so as not to slide when the handheld device 20 is inserted into the handheld protective case 25. Advantageously, if the two self-adhesive layer 11a overlap, this results in a very strong loop 11. Further still, if a portion of either of the two self-adhesive layer 11a is left without overlapping onto the other self-adhesive layer 11a, the non-overlapping portion can be used to prevent sliding of the loop 11 by affixing the loop 11 to the handheld protective case 25, the handheld device 20, or both. FIG. 13 is a back view of the assembly of the example back strap loop 11 of FIG. 11A, example protective case of FIG. 11A, and example smartphone of FIG. 11A and the interaction with a hand 30, provided according to an embodiment of the present application. Advantageously, the size of the loop 10 is adjustable to the size of the hand 30 such that the proper fit can be achieved for a particular purpose by the end user. For example, the remaining portion of the back strap loop 11 between the two opening in the case can be lengthened or shortened by moving the relative position on the inside face of the protective case 25b where each of the back strap 11s self adhesive layer is affixed. Advantageously, the back strap loop 11 thus formed may enable single-handed use for some handheld devices that would otherwise be awkward to manipulate with one hand 30, such as larger smartphones, phablets, tablets, etc. (ex: iPhone 6™, Galaxy Note™, iPad™ . . . ), as well as improving single-handed use for other handheld devices by allowing a more stable and relaxed grip for extended uses, such as photography, data taking, emailing and the like. The phone may also hold by itself onto one's hand when properly fitted.

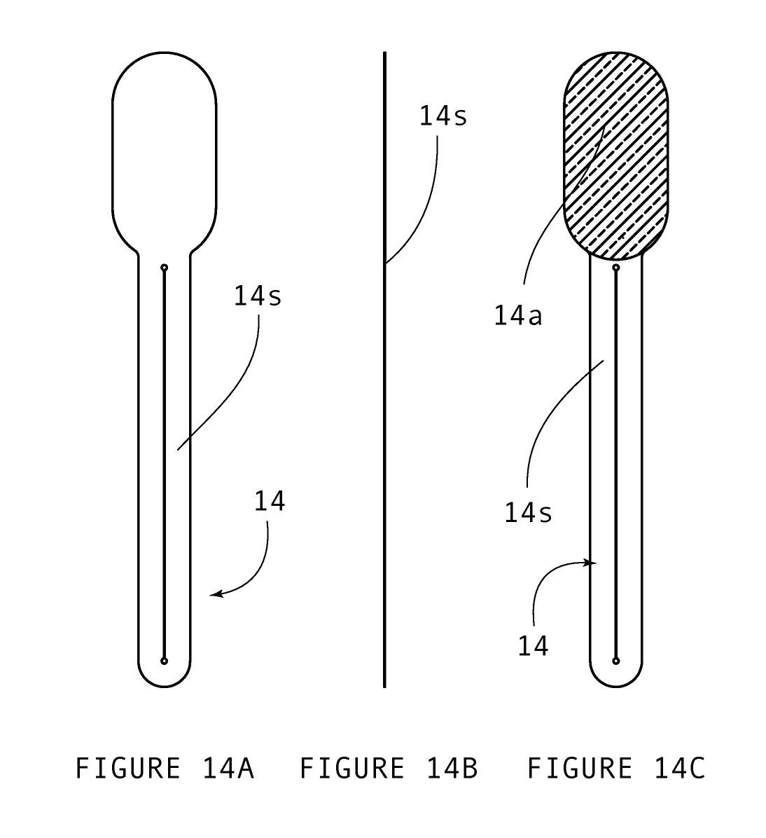

FIG. 14A is a front view of an of an example flat strap 14s, provided according to an embodiment of the present application. FIG. 14B is a right side view of the example flat strap 14s of FIG. 14A, provided according to an embodiment of the present application. FIG. 14C is a back view of the example flat strap 14s of FIG. 14A, showing a self-adhesive layer, provided according to an embodiment of the present application. Compared with the loops so far described, the embodiments the flat strap loop 14 has a slit cut into it at manufacture, such as by die-cut. Different profile cutting may exist. This embodiment is particularly well suited to satisfy the manufacturing process for wristband identification makers, such as used in amusement parks, concerts, and other like venues. The flat strap loop 14 is preferably made of Tyvek™ or the like materials, but other materials are contemplated as well. As illustrated the flat strap self-adhesive layer 14a (at least one affixing portion, strap-affixing portion) is wider than the remainder of the flat strap 14s. In some embodiments, the width of the flat strap 14s self-adhesive layer is substantially the same as the remainder of the flat strap 14s. In some embodiments, when used as a wristband identification marker, the flat strap 14s self adhesive layer is affixed to an object once a person has put their hand 30 through the loop 10 such that removing the loop 10 from the hand 30 would be difficult without altering the integrity of the flat strap loop 14. A person of ordinary skill in the art is thus enabled to adapt the flat strap loop 14 for use as a wristband identification marker in conjunction with any number of handheld objects, including but not limited to the example handheld objects illustrated in the other figures of this application, or described in this application.

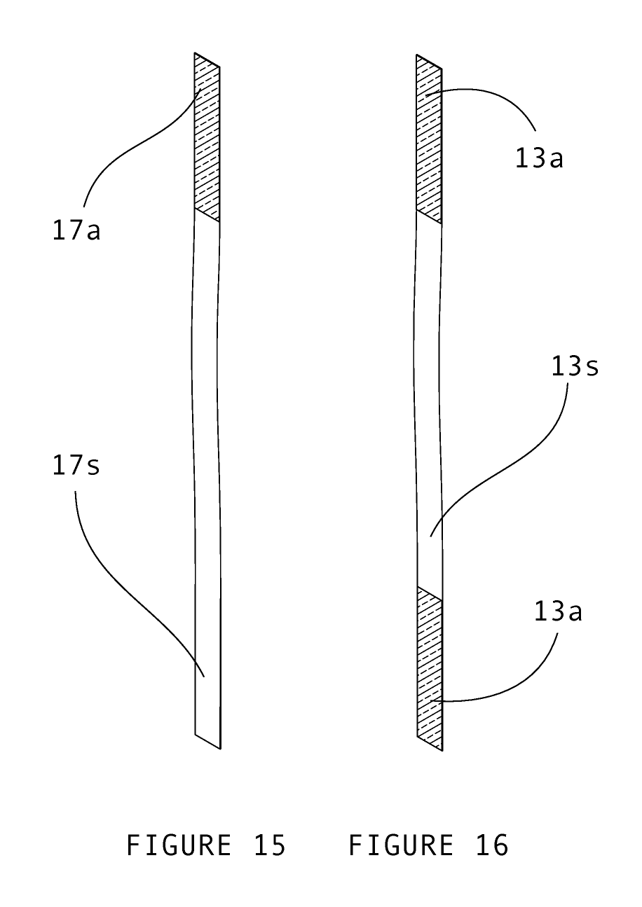

FIG. 15 is a perspective view of an example single end self-adhesive strap 17s, provided according to an embodiment of the present application. As illustrated, the single end self-adhesive strap 17s has the advantage that it is very simple to manufacture, and can be further processed to produce many embodiments of the present application. Advantageously, the single end self-adhesive strap 17s has a single end self-adhesive layer 17a (at least one affixing portion, strap-affixing portion) at one end, and the remainder of the single end self-adhesive strap 17s is provided without a self-adhesive layer. A loop 10 can be provided by folding over the single end self-adhesive strap 17s such that the bottom end is brought up towards the top end and at least a portion of the remainder of the single end self-adhesive strap 17s is put in contact with the single end self-adhesive layer 17a provided at the top end thereby forming a top and a bottom end of a loop 10. If the two ends of the single end self-adhesive strap 17s are substantially flush when forming the top end of the loop 10, then providing additional adhesive on the top end of the loop 10 may be required for some applications. Alternatively, if the two ends of the single end self-adhesive strap 17s are offset such that a portion of the single end self-adhesive layer 17a is exposed, the exposed portion thereby forms the strap self-adhesive layer 10a of the loop 10. Alternatively still, if a slit is cut in the remaining portion of the single end self-adhesive strap 17s, then a flat strap loop 14 is provided. Further alternatively, if the bottom end of the single end self-adhesive strap 17s is provided with a second single end self-adhesive layer 17a, then a double end self-adhesive strap 13s is provided from which yet further alternative embodiments can be provided, as will be described in reference to the next figure. Although not expressly shown in the drawing, it is contemplated to place the self-adhesive layer 17a (at least one affixing portion, strap-affixing portion) at any place on the flat strap 17s, such as the top end, bottom end, or anywhere in-between, on the front side or on the back side; furthermore it is contemplated that the self-adhesive layer can take any shape or form. Furthermore, although not expressly shown in the drawing, single end self-adhesive strap 17s can be formed into a loop by affixing back strap 17s onto itself, in the manner of a wristband, such that the single end self-adhesive strap 11s acts as a workpiece object, either alone, or in combination with a handheld protective case. For example, if the self-adhesive layer 17a is placed on one side of the back strap 11s, folding-over single end self-adhesive strap 17s after having passed one end through the camera protective opening of a handheld protective case and the other end through either the main or data port protective case opening results in an assembly wherein the single end self-adhesive loop can be freely slid while assembled to the handheld protective case when the handheld device is not inserted into the handheld protective case, and more solidly affixed so as not to slide when the handheld device is inserted into the handheld protective case. Further still, if a portion of the self-adhesive layer is left without overlapping onto the remainder of the single end self-adhesive strap, the non-overlapping portion can be used to prevent sliding of the loop by affixing the loop to the handheld protective case, the handheld device, or both.

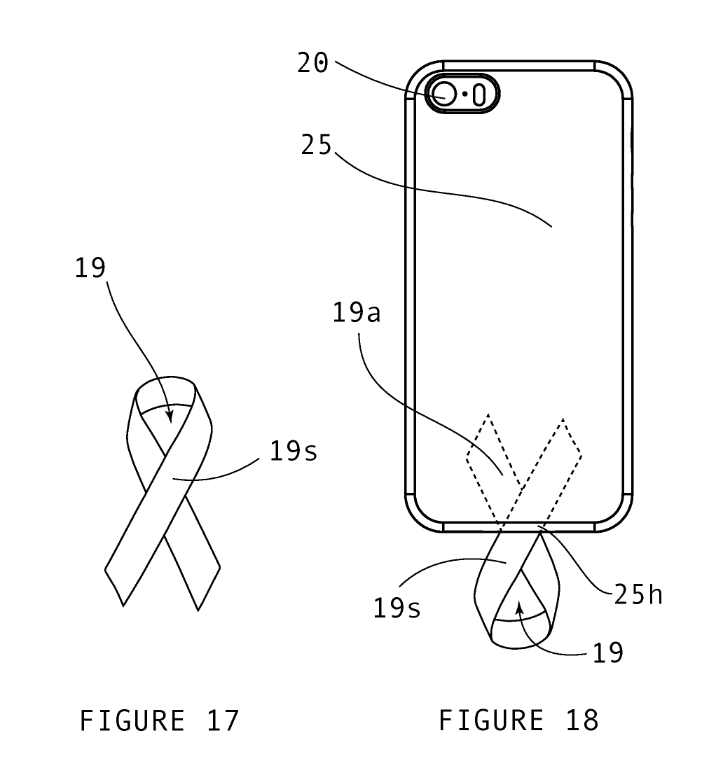

FIG. 16 is a perspective view of an example double end self-adhesive strap 13s, provided according to an embodiment of the present application. As illustrated, the double end self-adhesive strap 13s has the advantage that it is very simple to manufacture, and can be further processed to produce many embodiments of the present application. In fact, the strap 13 may be manufacture from the same continuous roll of 17s in FIG. 15 by simply shifting the cut so that 17a is cut in half. Advantageously, the double end self-adhesive strap 13s has two double end self adhesive layer each provided at both ends of the double end self-adhesive strap 13s, and the remainder of the double end self-adhesive strap 13s is provided without a self-adhesive layer. A loop 10 can be provided by folding over the double end self-adhesive strap 13s such that the bottom end is brought up towards the top end and at least a portion of the remainder of the double end self-adhesive strap 13s is put in contact with the double end self-adhesive layer 13a (at least one affixing portion, strap-affixing portion) provided at the top end thereby forming a top and a bottom end of a loop 10. If the two ends of the double end self-adhesive strap 13s are substantially flush when forming the top end of the loop 10, then providing additional adhesive on the top end of the loop 10 may be required in some applications. Alternatively, if the two ends of the double end self-adhesive strap 13s are offset such that a portion of at least one of the double end self-adhesive layer 13a is exposed, the exposed portion thereby forms the strap self-adhesive layer 10a of the loop 10. Alternatively still, if the double end self-adhesive strap 13s is folded at both the top and bottom end, then a back strap 11s and back strap loop 11 is provided as described in FIGS. 9-13. Alternatively still, if the fold is such that the top and bottom end of the double end self-adhesive strap 13s come into contact at an angle, an awareness ribbon loop 19 is provided as illustrated in FIG. 17. Although not expressly shown in the drawing, it is contemplated to place each of the self-adhesive layers 13a (at least one affixing portion, strap-affixing portion) at any place on the flat strap 13s, such as the top end, bottom end, or anywhere in-between, on the front side or on the back side; furthermore it is contemplated that the self-adhesive layer can take any shape or form.

FIG. 17 is a front view of an example awareness ribbon loop 19, provided according to an embodiment of the present application. As illustrated, an awareness ribbon strap 19s is connected onto itself at an angle such that the awareness ribbon strap 19s provides an awareness ribbon loop 19. Advantageously, not only is the awareness ribbon loop 19 in the shape of an awareness ribbon, it also provides an awareness ribbon adhesive layer for affixing the awareness ribbon loop 19 to a handheld object for convenience and reliable use.

FIG. 18 is a front view of an assembly of the example awareness ribbon loop 19 of FIG. 17, example protective case of FIG. 1, and example smartphone of FIG. 1, provided according to an embodiment of the present application. Advantageously, not only is the awareness ribbon loop 19 in the shape of an awareness ribbon, it also provides an awareness ribbon self-adhesive layer 19a (at least one affixing portion, strap-affixing portion) for affixing the awareness ribbon loop 19 to an assembly of a handheld device 20 and a handheld protective case 25.

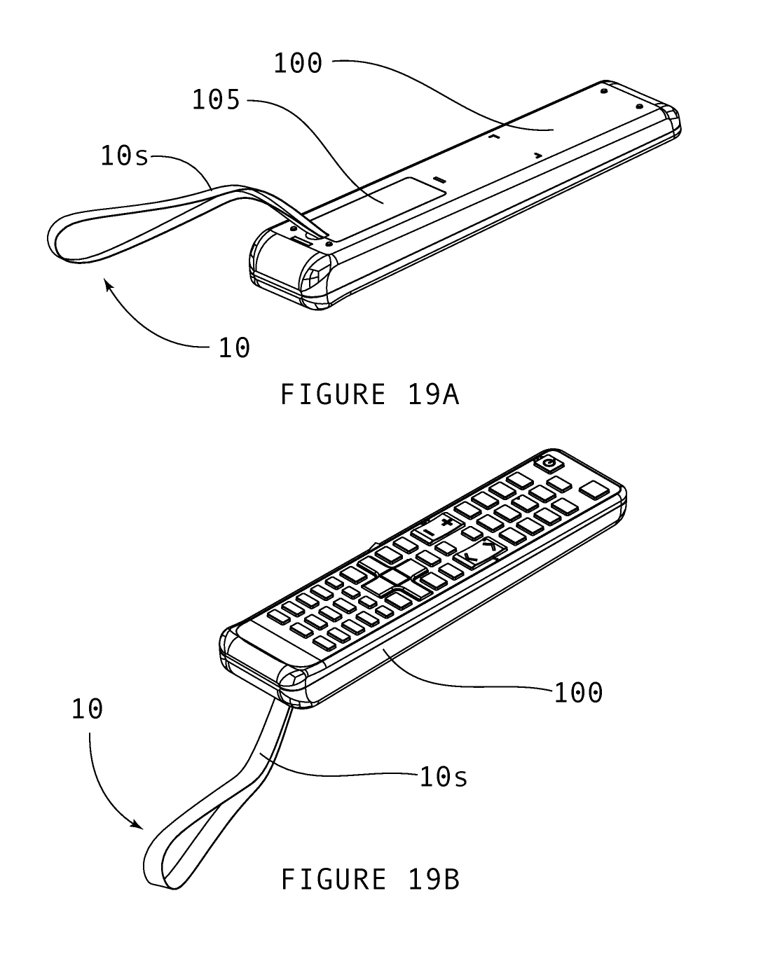

FIG. 19A is a back perspective view of an integration of the example loop 10 of FIG. 4 with an example remote control 100 device having a battery door 105, provided according to an embodiment of the present application. FIG. 19B is a top perspective view of the integration of the example loop 10 of FIG. 19A with the example remote control 100 device having a battery door 105 of FIG. 19A, provided according to an embodiment of the present application. In alternative embodiments, the top end of the loop 10 is affixed to the inside surface of the battery door 105, the inside surface of the remote control 100 under the battery door 105, affixed to at least one battery, and not affixed to anything but instead frictionally engaged between the assembly of the remote control 100 and the battery door 105. In one embodiment, the strap self-adhesive layer 10a of the loop 10 is affixed to the remote control 100 under the batteries thereby also providing a way to pull on the strap 10s to remove the at least one battery when it is time to replace the at least one battery. The use of a remote control 100 is exemplary such that a person of ordinary skill in the art is enabled to embody the application in any device having a battery compartment with a battery door 105 or the like.

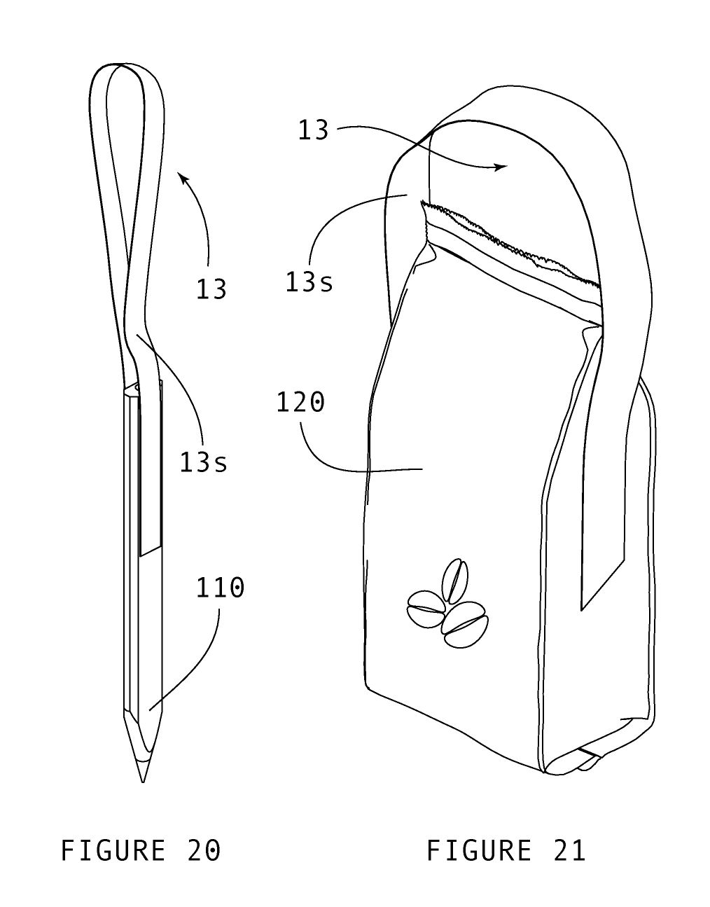

FIGS. 20 and 21 are perspective views of integrations of the example strap 13s of FIG. 16 with example products. The embodiment of FIG. 21 shows the extent and versatility of the strap as it provides a particle handle for a packaging solution of any product.

Some further alternative embodiments will be described. One embodiment comprises a flexible loop 10 that holds via adhesive onto a smartphone or its protective casing, and serves as a strap 10s for ease of grabbing. One embodiment enhances one-handed manipulation of the object and prevents the object from accidental drops. Optional microfiber patch 10C may also hold acronyms, slogans, patterns, logos, symbols, brand marks, etc. Material may also be Tyvek™, plastic or vinyl like wristbands for public events. One-dimensional cutting pattern should also satisfy the manufacturer processes for wristband identification makers. See FIG. 13. Cutting pattern may exist in any shape. One design could also satisfy all applications. A ribbon with adhesive on both ends could be installed as a hanging loop 10, FIG. 1, or as a back strap loop 11, as on FIG. 13. The loop 10 would then pass through openings in the protective case, such as for camera and data port. Dimensions of the loop 10, back strap loop 11, flat strap loop 14, awareness ribbon loop 19 may be of any size appropriate for a specific application. Accessories may be added to the apparatus, such as rings, clips, ornaments, reels, leashes, chains, etc. For example, adding a key ring 70 would allow a user to slip a finger into the ring to quickly secure the device. Although not expressly shown in the drawing, it is contemplated that embodiments of the present application enable an object to be hung, supported, or otherwise configured so as to render the object hands-free or hands-relaxed. For example, some embodiments of a loop enable an object to be propped up onto any number of items that are readily available (pencils, erasers, coat hangers, hooks, fingers, etc.). The propping up of a handheld device for in this manner is ideal for viewing content on the screen of the device in either a hands-free or hands-relaxed fashion. On the latter point, a loop affixed to an object can be placed on a hand such that a portion of the hand (e.g. one or more fingers) uses the loop to support the object without having to clasp the object to keep it from falling, thereby resulting in a hands-relaxed use of the object. Although not expressly shown in the drawing, material of the loop is one of at least, elastic, inelastic, plastic, polyester ribbon, microfiber, card, paper, kraft paper, and high-density polyethylene fibres.

Since other modifications and changes varied to fit particular operating requirements and environments will be apparent to those skilled in the art, what is desired to be protected by Letters Patent is not considered limited to the example chosen for purposes of disclosure, and covers all changes and modifications which do not constitute departures from the true spirit and scope of this application, which is set forth in the claims.

What is claimed is:

1. A loop suitable for use with an object, the loop comprising:
a strap having a top end and a bottom end folded-over and affixed to each other thereby forming a front side, a backside, an outside face, and an inside face of the loop;
a self-adhesive portion provided at the top end and the backside of the loop suitable for affixing the loop to the object;
a microfiber cloth provided in one of a clasp that wraps around the strap like a tube and a portion of the strap; and
wherein the bottom end of the loop hangs loose, such as a standard wrist strap would do, when the loop is affixed to the object.

2. A loop suitable for use with a workpiece object, the loop comprising:
a strap having a top end and a bottom end and a portion in-between;
a first self-adhesive portion provided at one of the top end, bottom end, and the portion in-between;
a second self-adhesive portion provided at one of the top end and, bottom end, and the portion in-between; and
wherein the first and second self-adhesive portions are suitable for affixing the strap to the workpiece object thereby forming the loop.

3. A loop suitable for use with an object, the loop comprising:
a strap having a top end and a bottom end;
an affixing portion including a self-adhesive portion provided at one of the top end, bottom end, and
in-between the top end and the bottom end, of the strap;
wherein the strap is one of folded-over and cutted to form the loop; and
wherein the affixing portion provides at least one strap-affixing portion suitable for affixing the loop to the object.

4. The loop according to claim 3, wherein a length of the loop is suitable for one of an average human to use the bottom end of the loop as a wrist strap and an attachment to one of a cord, chain, carabineer, retractable reel, ring, and leather strap.

5. The loop according to claim 3, wherein a microfiber cloth is integrated in the loop in one of a clasp that wraps around the strap like a tube and a portion of the strap.

6. The loop according to claim 3, wherein a material of the loop is one of at least, elastic, inelastic, plastic, polyester ribbon, microfiber, card, paper, kraft paper, and high-density polyethylene fibres.

7. The loop according to claim 3, wherein a width of the strap is suitable for passing a portion of the strap in at least one opening in a protective case for a handheld device.

8. The loop according to claim 3, wherein a portion the strap is made from a material flexible enough and thin enough to have a thickness that is suitable for conforming a portion of the strap that includes the strap-affixing portion between two parts of an assembly.

9. The loop according to claim 3, wherein the two ends of the strap are joined together to form the top end of the loop by a junction.

10. The loop according to claim 9, wherein the junction is provided by one of heat welding, ultrasonic welding, adhesive transfer, tape and glue.

11. The loop according to claim 9, wherein the junction is one of a simple fold and a cross fold.

12. The loop according to claim 9, wherein the top end of the loop has a tip selected from one of an angle cut, V cut, straight cut, glue, and fold.

13. The loop according to claim 9, wherein the top end of the loop matches an exterior profile of curvature of a device.

14. The loop according to claim 3, wherein the loop includes at least one of a pattern, color, texture, brand mark, logo, drawing, writing, identifying the loop, trademark, branding icon, acronym and slogan.

15. The loop according to claim 3, wherein the strap includes an accessory including at least one of a bead, ring, clip, ornament, reel, leash, chain, and key ring.

16. The loop according to claim 3, wherein the loop is an awareness ribbon loop.

17. The loop according to claim 3, wherein the loop resists a human pulling force.

18. The loop according to claim 3, further comprising a packaging solution including at least one of a card and a protective liner, such that the loop is temporarily affixed to one of the card and the protective liner for packaging purposes.

19. The loop according to claim 3, wherein the object is at least one of a mobile phone, smartphone, tablet, electronic book, camera, remote control, portable diabetes device, protective case, container, wallet, keys, key ring, ID pass, beauty item, card, and a protective liner.

20. The loop according to claim 3, wherein the affixing portion includes at least one of a second self-adhesive layer, hook, T shaped tab, permanent affixing element, releasable affixing element, and integration as a part of the object; and wherein the affixing portion has adequate strength to support a weight of the object to ensure that a junction between the loop and the object remains intact if the loop is pulled.

21. The loop according to claim 3, further including a clasp that wraps around the strap like a tube.

22. The loop according to claim 3, wherein the affixing portion is provided by a self-adhesive layer that is non-permanent and non-marking so an integrity of the object where it is affixed is preserved, yet strong enough to resist shear forces of the order of a human pulling force.

23. The loop according to claim 3, further comprising at least an other affixing portion provided at an other of the bottom end, top end, and in-between the top end and the bottom end, of the strap.

24. The loop according to claim 23, such that the one affixing portion and the other affixing portion are suitable to be affixed to a workpiece thereby providing the loop.

25. The loop according to claim 24, wherein the workpiece is at least one of the object, a protective case for the object, and the strap.

26. The loop according to claim 25, wherein the strap is affixed to the protective case via at least one opening in the protective case selected from a feature opening and an opening intended to receive the object for which the protective case provides protection.

27. The loop according to claim 26, wherein the feature opening includes one of a speaker opening, a camera opening, a data port opening, and an other opening.

28. The loop according to claim 3, wherein a size of the loop is adjustable to the size of a hand of a person.

29. The loop according to claim 3, wherein the loop enables a person to at least one of operate the object with one hand, locate the object, pull the object, wear and secure the object on a wrist, hand or fingers, use the object in a hands-free fashion, use the object in a hands-relaxed manner, and prevent the object from falling.

30. The loop according to claim 3, wherein a cutting profile for cutting the strap is a die-cut and the loop further provides a printing area for one of a wristband identification marker and an other designs.

31. The loop according to claim 30, wherein once affixed to the object, removing the loop from a wrist would compromise an integrity of the wristband identification marker.

32. The loop according to claim 3, wherein the affixing portion is one of a wider width and a same width as a remaining portion of the strap.
